(19) United States
(12) Patent Application Publication
(10) Pub. No.: US 2012/0178069 A1
(43) Pub. Date: Jul. 12, 2012

(54) Surgical Procedure Planning and Training Tool

(76) Inventors: Frederic D. McKenzie, Norfolk, VA (US); Sebastian Bawab, Chesapeake, VA (US); Krzysztof Rechowicz, Norfolk, VA (US); Stephen Knisley, Norfolk, VA (US); Frazier Frantz, Chesapeake, VA (US); Robert E. Kelly, JR., Norfolk, VA (US)

(21) Appl. No.: 13/161,093

(22) Filed: Jun. 15, 2011

Related U.S. Application Data
(60) Provisional application No. 61/354,934, filed on Jun. 15, 2010.

(51) Int. Cl. G09B 23/28

(52) U.S. Cl. 434/262

(57) ABSTRACT

Computer systems and methods are provided for training surgeons to perform the Nuss procedure, a surgery for correcting pectus excavatum (PE), and for planning such procedures. PE is a congenital chest wall deformity, and the Nuss procedure is a minimally invasive surgery that involves implantation of a corrective bar. A surgical trainer and planner may be based on one or more of the biomechanical properties of the PE ribcage, deformable models, and visualization techniques.

### CROSS-REFERENCE TO RELATED APPLICATIONS

This application claims the benefit of U.S. Provisional Patent Application No. 61/354,934, titled “SURGICAL PROCEDURE PLANNING AND TRAINING TOOL,” filed on Jun. 15, 2010, which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records but otherwise reserves all copyrights whatsoever.

### BACKGROUND

Pectus excavatum (“PE”), also called sunken or funnel chest, is a congenital chest wall deformity which is characterized, in most cases, by a deep depression of the sternum. This condition affects primarily children and young adults and is responsible for about 90% of congenital chest wall abnormalities. Typically, this deformity can be found in approximately one in every 400 births and is inherited in many instances. FIG. 1 depicts a male with PE.

Among various PE treatment options, a minimally invasive technique for the repair of PE, which is often referred to as the Nuss procedure, has been proven to have a high success rate, satisfactory aesthetic outcome and low interference with skeletal growth. In the Nuss procedure, one or two curved metal bars (FIG. 1) are surgically inserted into the chest of the patient and then flipped to lift and hold the chest in place, thus correcting the depression in the chest. PE patients that undergo minimally invasive surgery, such as the Nuss procedure, report an improved ability to exercise, and measures of cardiac and pulmonary function show improvement in the long term.

The Nuss procedure starts with small bilateral incisions on the side of the torso aligning with the deepest point of the depression. Using a surgical tool, the surgeon opens a pathway from the incision, up between the skin and ribs then down under the sternum, taking care not to puncture the lungs or heart, and, finally, back up through and over the ribs and out the opposite incision. Then, a steel bar, previously bent to suit the patient, is pulled through the pathway. At this time, if the position of the bar is correct, the surgeon can slowly elevate the bar to loosen the cartilage connections to the inner thorax. After this step, the concave bar is then flipped convex, so that the arch elevates and supports the sternum in a normal position. The bar is then sutured into place, often with the addition of a stabilizer to prevent movement. In some cases when PE is severe or when a patient is adult, a second and even a third bar may be inserted. After a period of at least two years, the bar is removed, resulting in a largely permanent result.

Apart from a physical improvement, positive psychological results are attributed to surgical correction, because a normal shape of the chest is restored, reducing embarrassment, social anxiety, and depression that may accompany PE. A positive aesthetic outcome may therefore be considered an essential criterion for a successful surgery.

### BRIEF SUMMARY OF THE INVENTION

Embodiments of the invention relate to a Nuss procedure surgical planner that may take into account the biomechanical properties of the PE ribcage, deformable models, and visualization techniques. A surgical planner according to an embodiment of the invention may be used to achieve the optimal outcome for a surgery, which may include achieving a positive aesthetic outcome. Achieving such an outcome may depend on the correct placement of the bar, and embodiments of the invention may include computer systems that allow a surgeon to practice and review possible strategies for placement of the corrective bar and the associated appearance of the chest.

An embodiment of the invention comprises a computerized method of simulating a surgical procedure intended to modify the shape of a portion of a patient's body. The method comprises measuring physical attributes of the relevant portion of the body of the patient who is to undergo the procedure. Some or all of the measurements may be mapped to a computerized parametric model of the anatomic structure and the mapped measurements may be supplied as parameters to the parametric model to generate a first model of the anatomic structure of the patient. The method also comprises using the first model directly or indirectly to simulate the response of the anatomic structure to simulated actions of a surgeon performing the procedure.

In an embodiment of the invention, simulating interactively the response of the anatomic structure to simulated actions of a surgeon performing the surgical procedure comprises repeatedly receiving from at least one input device operatively coupled to at least one of the processors input that represents application of one or more forces during surgery to one or more parts of the anatomic structure; in response to the received input that represents application of one or more forces during surgery, executing instructions by at least one of the processors to calculate, using the first model directly or indirectly, one or more resulting forces and one or more displacements of the anatomic structure in response to the applied forces; and transmitting to at least one output device operatively coupled to at least one of the processors output representing one or more of the resulting forces, one or more of the displacements, or both.

In an embodiment of the invention, the computer system comprises a positional input device that comprises an element that is capable of detecting movement in three dimensions, and the input provided by the positional input device includes information representing all dimensions of movement of the element. According to one such embodiment of the invention, the computer system further comprises a haptic output device. According to a further such embodiment of the invention, the positional input device and the haptic output device are the same device; the output provided to the haptic output device represents one or more resulting forces; and the haptic output device exerts a force on a user that corresponds to the one or more resulting forces.

In an embodiment of the invention, the first model comprises a finite element model. According to a further embodiment of the invention, the method comprises generating a second model based on the first model, wherein the second model comprises an artificial neural network; generating the second model comprises using the first model to simulate the response of the anatomic structure to application of one or more external forces; the first model is used indirectly to simulate interactively the response of the anatomic structure to the simulated actions of the surgeon performing the surgical procedure; and using the first model indirectly to simulate the response of the anatomic structure to the simulated actions of the surgeon comprises using the second model directly to simulate the response of the anatomic structure to the simulated actions of the surgeon.

In an embodiment of the invention, the surgical procedure comprises insertion of one or more curved metal bars into the chest of a patient to correct an abnormal depression of the patient's sternum, and the anatomic structure comprises the patient's ribcage and associated tissues. In an embodiment of the invention, the method comprises receiving through an interface operatively coupled to at least one or the processors information representing the sizes and shapes of the metal bars, wherein simulating the response of the anatomic structure reflects the information representing the sizes and shapes of the metal bars.

Embodiments of the invention also comprise computer systems configured to carry out the above methods and computer-readable storage media encoded with instructions that, when executed by a processor within a computer system, cause the computer system to carry out the above methods.

### BRIEF DESCRIPTION OF THE DRAWINGS

FIG. 1 depicts the chest of a male with PE and a metal bar such as may be inserted according to the Nuss procedure.

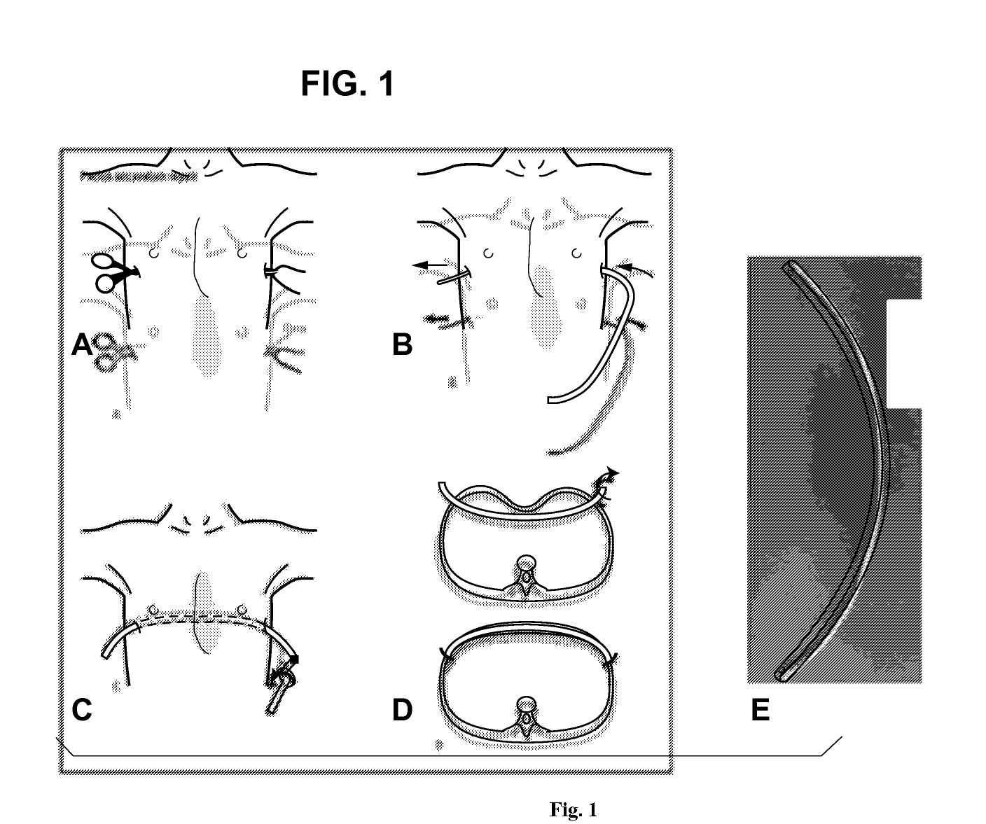

FIG. 2 depicts use of a Nuss procedure planner or simulator according to an embodiment of the invention.

FIG. 3 is a flow diagram that depicts preparation and use of a simulator according to an embodiment of the invention.

FIG. 4 depicts segmented rib and cartilage information such as may be obtained in connection with an embodiment of the invention.

FIG. 5 depicts a parametric model of a ribcage.

FIG. 6 is a block diagram depicting elements of a computer system such as may be used in connection with embodiments of the invention.

FIG. 7 is a block diagram of networked computer systems such as may be used in connection with embodiments of the invention.

### DETAILED DESCRIPTION OF PREFERRED EMBODIMENTS

Embodiments of the invention may comprise simulation of the Nuss procedure for the purposes of training surgeons to perform the procedure, planning procedures to be done on actual patients, or both. A simulator may comprise, for example, a computerized model of the mechanical properties of bones and other tissues. The simulator may accept input, e.g., from a mechanical input device, corresponding to the actions of a surgeon performing the procedure, and it may provide output, e.g., in the form of real-time mechanical feedback (such as resistance to movement) of this input device or otherwise. A simulator may also provide visual output, e.g., a display of one or more aspects of the chest or ribcage during the procedure, and such a display may be updated, e.g., in real time as the simulation proceeds.

In connection with embodiments of the invention, there may be two main elements to the planning of the Nuss procedure. The first is whether to place one or two bars and where to place them. This is determined by the nature of the depression for a particular patient. If the depression is significantly elongated, two bars may be needed. The location of the deepest part of the depression also determines which rib(s) will be supporting the bar(s).

The second main element is the curvature of a bar. Inadequately curved bars can cause significant discomfort to the patient and a suboptimal long term aesthetic improvement.

Typically, the metal bars are bent to conform to the chest of the patient during the surgical procedure in the operating room. As is known in the art, these bars can place stress not only on the sternum and ribcage but also on the vertebral column, causing significant pain and discomfort to patients after surgery. One can speculate that improperly shaped bars will contribute to this discomfort.

An embodiment of the invention may be used in connection with planning either or both elements. For example, a surgical planner according to an embodiment of the invention may identify the optimal placement of the bar(s) and also the optimal curvature of the bars. Embodiments of the invention may allow surgeons to determine whether to use one bar or two, where to place incisions, where best to insert the bar(s) into the chest cavity after tunneling under the skin, and to infer the best curvature for the bar(s).

In an embodiment of the invention, a model of the chest may be used to predict the shape of the patient's chest following the procedure, based on the number, shape, and placement of bars. For example, in an embodiment of the invention, published tissue property approximations obtained ex-vivo may be used to populate a biomechanical finite element (FE) model that will be used to create a force/displacement (F/D) approximation using a black box approach that will mimic the behavior of the pectus excavatum ribcage when given incision, insertion, and pectus bar parameter inputs. The result will be a predicted shape that will be compared to subject specific post-surgical chest shapes for validation.

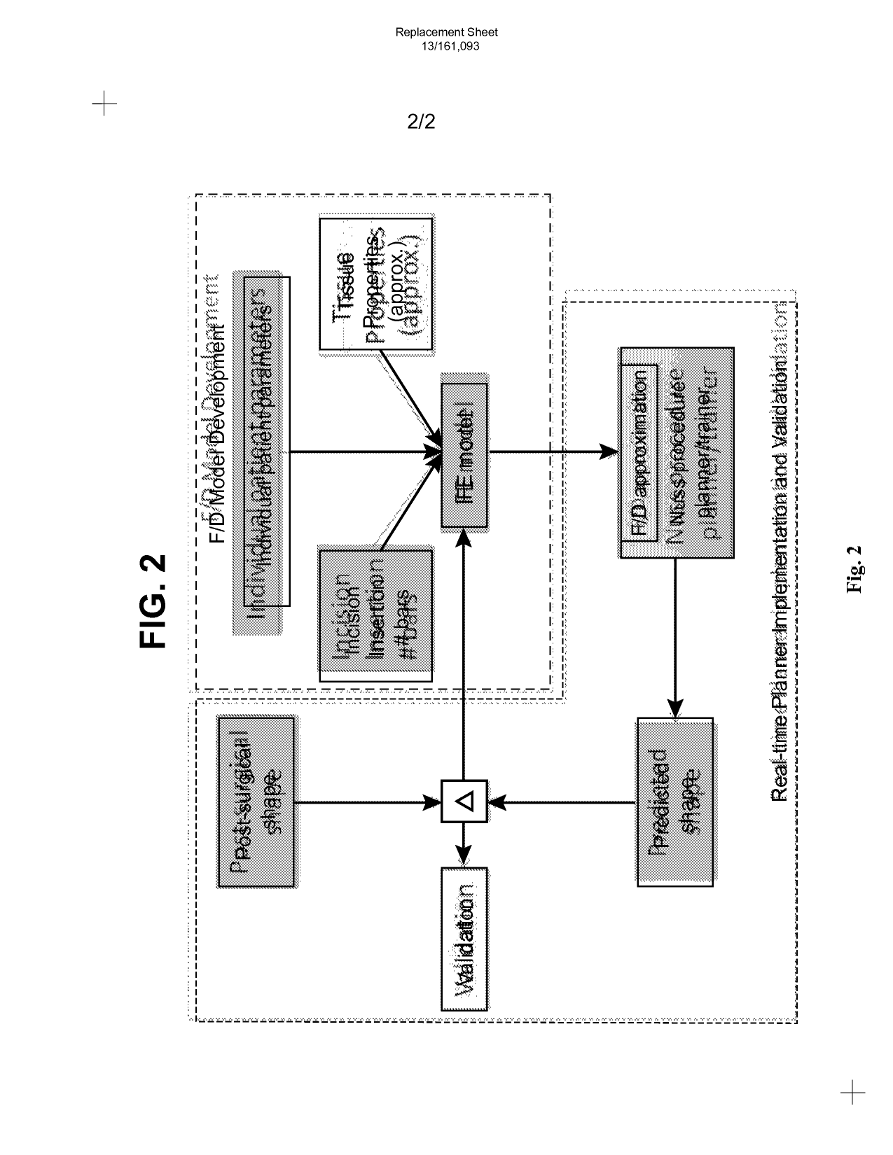

FIG. 2 depicts use of a FE model in connection with such a surgical planner.

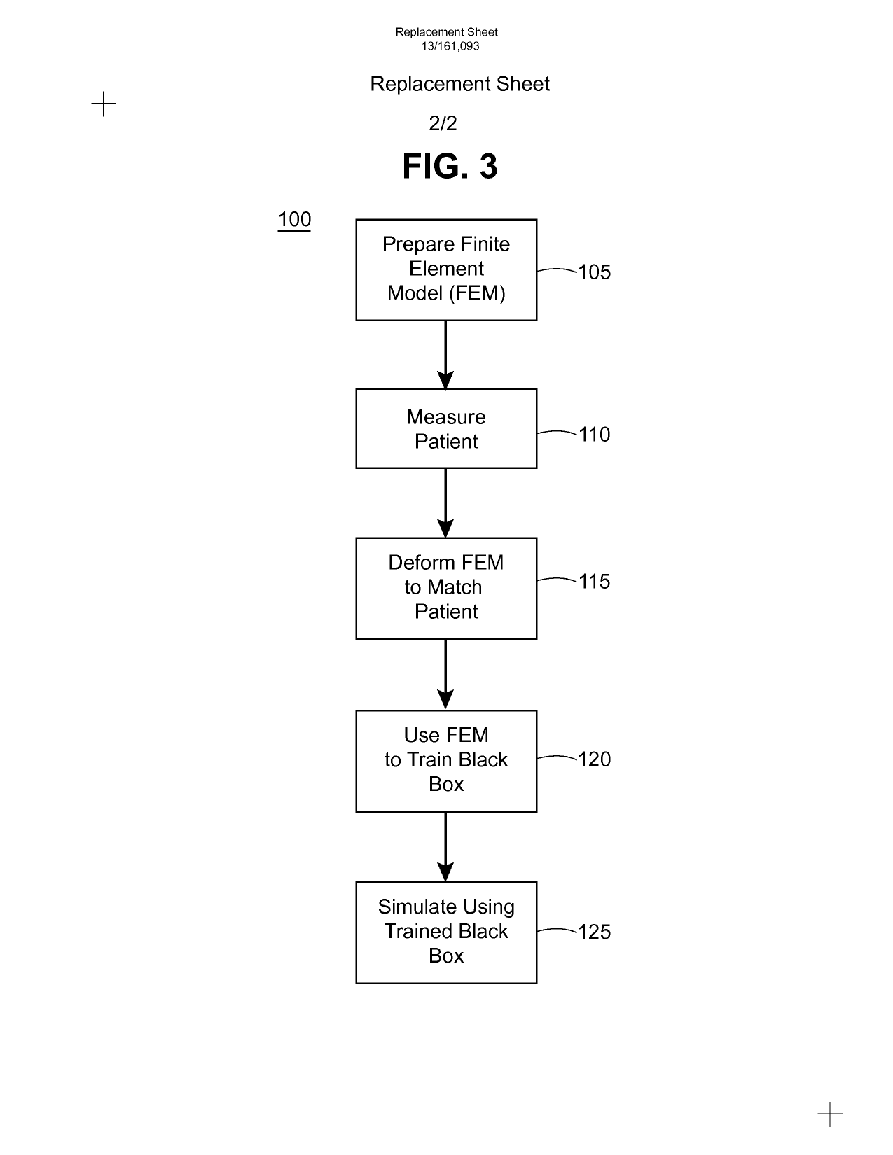

FIG. 3 is a flow diagram that depicts from a high level the use 100 of a Nuss procedure simulator according to an embodiment of the invention. As depicted, the flow begins in block 105 with preparation of a finite element model (“FEM”) of a ribcage. Finite element modeling is a well-known technique in which a continuous domain is represented by a mesh of discrete subdomains.

In an embodiment of the invention, for example, a FEM of the ribcage may be built from approximately 15,500 2D triangular elements. In connection with an embodiment of the invention, certain simplifying assumptions may be made. For example, the elements may be chosen to represent only the surface, e.g., if only the external nodes are expected to take part in the visualization.

As another simplification, the FEM may be reduced to only part of the ribcage, e.g., the part of the ribcage that commonly undergoes significant deformation during the Nuss procedure. In an embodiment of the invention, such a reduction may limit the number of elements or nodes in the FEM to approximately 3,500. In such an embodiment, the rest of the model can be assumed to be static and recreated as a separate model combined with the deformed part. For example, the FEM may be constrained at the end of each remaining part of the rib after cutting off the posterior static part.

Other ways to simplify the FEM and/or the process of creating one will be apparent to those skilled in the art. It will be appreciated that any one or more such simplifications may be used in connection with an embodiment of the invention in combination with or instead of any one or more simplifications discussed herein.

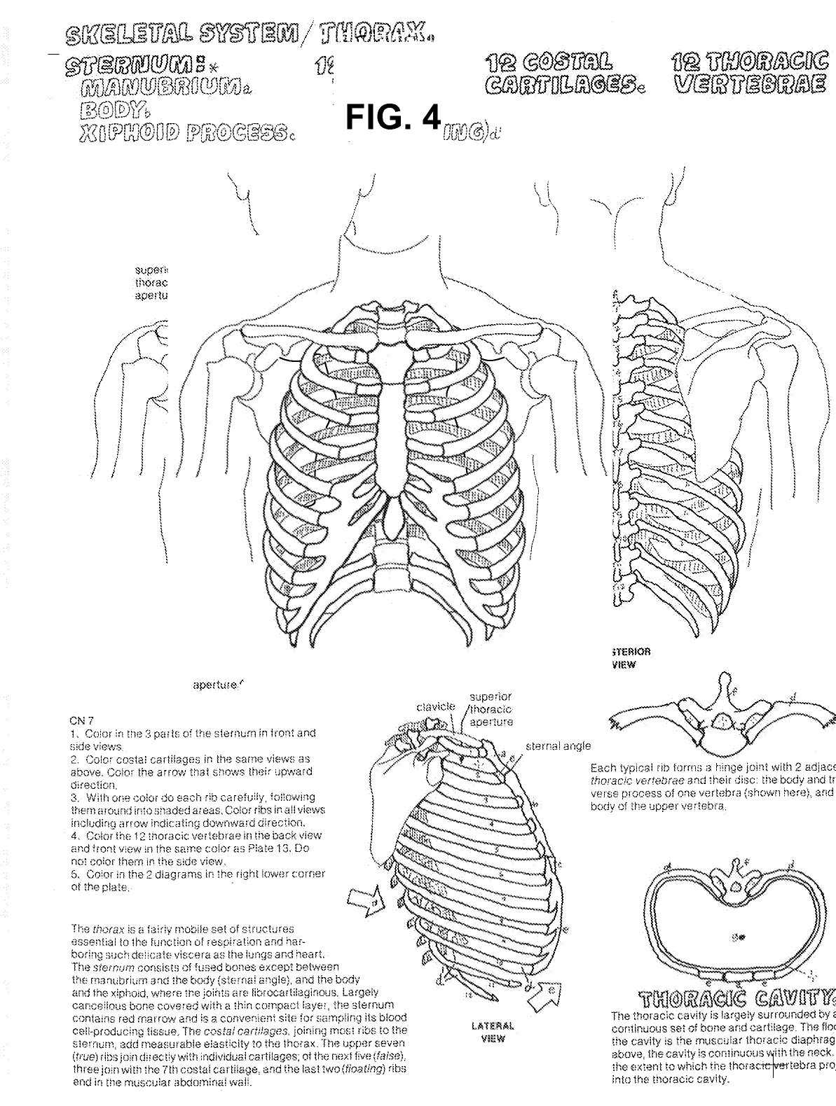

Developing a FEM for use in connection with an embodiment of the invention may comprise collecting, e.g., computed tomography (CT) data and segmenting the rib and cartilage information. This process may involve collecting a number of CT data sets documenting PE cases prior to the surgery. FIG. 4 depicts a visualization of such segmented rib and cartilage information.

Note that finite element (“FE”) analysis may take into account the mechanical properties of the tissue being modeled. Persons skilled in the art are known to differ regarding the values of these properties, such as, e.g., the material properties related to PE cartilage. One alternative in connection with an embodiment of the invention is to use values suggested in publications such as, for example: P. Chang, Z. Hsu, D. Chen, J. Lai, and C. Wang, “Preliminary analysis of the forces on the thoracic cage of patients with pectus excavatum after the nuss procedure,” Clinic Biomech, vol. 23, no. 7, pp. 881-885, 2008; B. Gzik-Zroska, D. Tejszerska, and W. Wolański, “Stress analysis in funnel chest stabilization with a plate,” Modelowanie Inżynierskie, vol. 34, pp. 37-42, 2007; and J. Feng, T. Hu, W. Liu, S. Zhang, Y. Tang, R. Chen, X. Jiang, and F. Wei, “The biomechanical, morphologic, and histochemical properties of the costal cartilages in children with pectus excavatum.” J Pediatr Surg, vol. 36, no. 12, pp. 1770-1776, December 2001 [Online] (Available: http://dx.doi.org/10.1053/jpsu.2001.28820).

The FE analysis in connection with an embodiment of the analysis may involve two kinds of variables: locations of acting forces and their magnitude. Location will follow possible contact zones, whereas magnitudes will be varied incrementally within a practical range. Resulting displacements can be stored with respect to the force, which later on can be used for constructing the model relating force to displacement.

Instead of or in addition to referring to the references cited above for the properties of PE tissues, tissue properties may be obtained in other ways, e.g., by measuring the actual properties of tissue of one or more persons, possibly including a patient upon whom the Nuss procedure is to be performed. For example, a robot arm device may be used to apply force and measure deflections of the rib cage within the fraction of a second it takes to do so. Once force deflection data is collected, these values can be used as input to the FE model of the patient's chest area, thereby estimating the material properties of the PE rib cage.

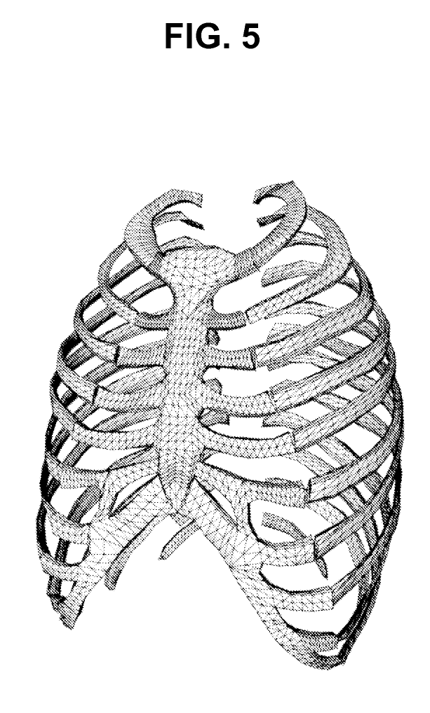

In an embodiment of the invention, block 105 of FIG. 3 may comprise generating a parametric model of a PE ribcage. FIG. 5 depicts such a parametric model. In block 110 of FIG. 2, a patient may be measured, e.g., mechanically and/or by CT scan. Individual measurements, e.g., obtained from CT slices, may in an embodiment of the invention be mapped to parameters of a model such as FIG. 4 depicts. Block 115 of FIG. 3 corresponds to deforming such a model, based upon individual patient parameters obtained from CT slices, to fit the PE ribcage, according to an embodiment of the invention.

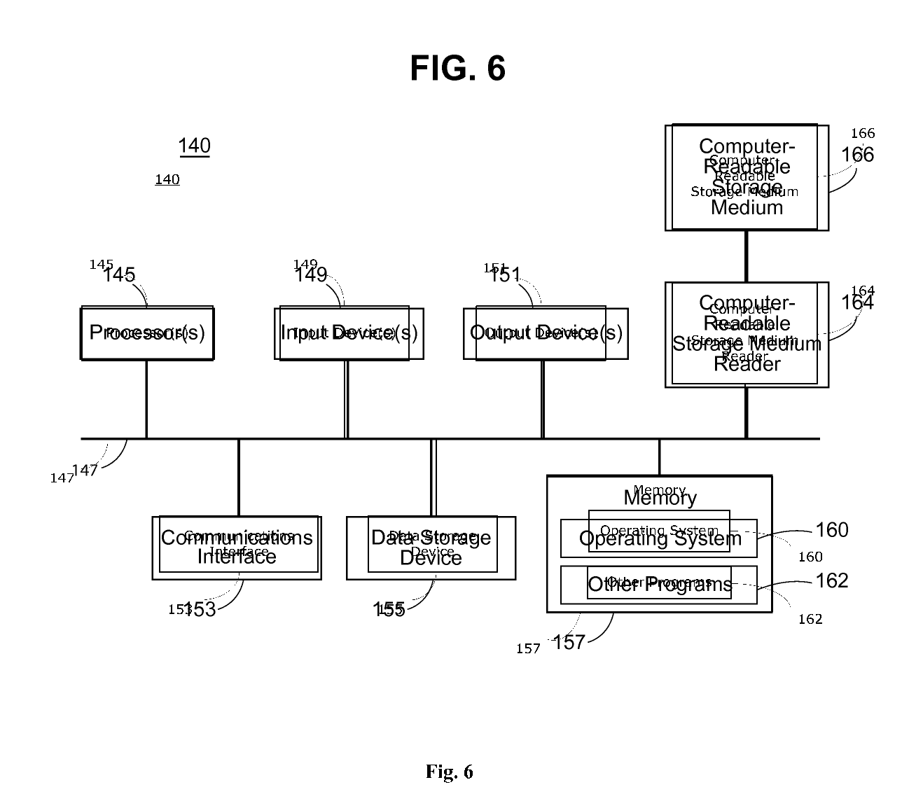

Based on the 2D elements, for the purposes of finite element analysis (FEA), a volume mesh may be created to provide realistic deformation of the model. FIG. 6 depicts such a mesh according to an embodiment of the invention.

As discussed below, it may be considered desirable in connection with an embodiment of the invention for a surgical trainer or planner to respond to user inputs in real time. For example, it may be desired that a simulation of a procedure update in response to user input with no or minimal delay perceptible to the user. FE modeling may in a particular computational environment be sufficiently computationally burdensome, in an embodiment of the invention, that real-time performance may not be guaranteed, and another approach may be appropriate in such an embodiment.

One such approach, for example, may involve approximating the FE model with a “black box”. In an embodiment of the invention, for example, the black box may comprise an artificial neural network (“ANN”). Once trained, the ANN may accept inputs, such as, for example, the locations, directions, and magnitudes of one or more forces applied to a modeled PE ribcage. The outputs of the ANN may indicate displacements of points within the modeled ribcage.

Block 120 in FIG. 3 represents using the FEM, deformed to reflect measurements of a particular patient, to train an ANN according to an embodiment of the invention. Training the ANN may comprise, e.g., repeatedly simulating the application of forces in the FEM to obtain deformations. This process may be repeated with different force settings upon variable forces. The applied forces and the resulting displacements or deformations may be used as training data for the ANN.

The design and/or training of the ANN may be additionally simplified in an embodiment of the invention. For example, only displacement of the surface nodes of the FEM may be recorded to be used in the artificial neural network (ANN) training process.

Artificial Neural Networks are well-known in the art, as are multiple data structures and algorithms that may implement them. The precise data structures and algorithms may vary depending on the embodiment of the invention.

In an embodiment of the invention, the structure of ANN may follow from the FEM. For example, in one embodiment, the input layer may have 3 m+k+7 nodes where m is the number of nodes in the FEM (e.g., roughly 3500 nodes in the FEM discussed above), k is the number of geometric parameters describing a patient specific deformity (e.g., in an embodiment of the invention, from 6-10), and 7 is a number of parameters describing the force acting on the cartilage: x, y, and z coordinate of the contact node, x, y and z components of an unit force directional vector and its magnitude. Such a structure may result in approximately 10,500 nodes in the input layer. The output layer in this embodiment may consist of 3 m nodes, which may provide the displacement in three dimensions of all nodes. The number of nodes in the hidden layer in this embodiment may be approximately ⅓ of the number of nodes in the input layer.

Training data may be generated and supplied to the ANN until one or more stopping criteria are met. For example, in an embodiment of the invention, different configurations of the ANN may be trained with the stopping criterion being that the mean squared error becomes less than or equal to 0.01. In an embodiment of the invention, more than one ANN may be configured and trained, e.g., to determine the optimal number of hidden nodes or neurons. In such an embodiment, the ANN characterized by the smallest validation error may be chosen as the approximation of the force/displacement model.

Once the ANN has been trained, the weights may be used as the coefficients of an approximation of the force/displacement (F/D) model which will be implemented in a virtual environment so deformation can be visualized in the surgical trainer and planner.

Block 125 in FIG. 3 represents simulation of a Nuss procedure using, e.g., the approximated F/D model realized by the trained ANN. In an embodiment of the invention, the core model design of the surgical planner may be used to create a Nuss procedure surgical trainer. A trainer according to an embodiment of the invention may be haptic enabled to provide touch feedback to the user and provide intelligent performance feedback based on predicted shape outcomes and comparisons to an averaged normal shape and to known successful post-surgical results obtained for a specific case.

According to an embodiment of the invention, a user may use this system to pick up a virtual scalpel, make incisions on a virtual PE chest, choose and insert a pectus bar into the PE chest, then receive a performance score all while receiving visual and touch feedback. Because the bar will be interacting with the ribcage, the interacting forces will be constantly scanned in order to calculate deformations and rebuild the surface model. The same forces can be fed back to the user through the haptic interface. The system is meant to provide intelligent performance feedback based on predicted shape outcomes and comparisons to an averaged normal shape and to known successful post-surgical results for a specific case. All may be performed while receiving 2D and/or 3D visual and touch feedback, which may include, e.g., one or more images of the simulated ribcage and/or chest upon which the procedure is being simulated.

It will be appreciated that the simulation in block 125 may be implemented in the form of a loop, in which user input is received, the model is deformed based on the input, and the deformation is used to provide calculated visual and/or haptic output. In response to this output, and at least partially affected by it, the user may provide further input, and the process may repeat until the end of the simulation.

A simulator may be implemented using one or more third-party platforms. For example, in an embodiment of the invention, one or more commercially available platforms, frameworks, and/or toolkits may be used to implement some or all functions of the simulator. One such platform that may be suitable for use in connection with an embodiment of the invention is 3DVIA VIRTOOLS, which is commercially available from Dassault Systèmes.

It will be appreciated that various nuances can lead to suboptimal aesthetic results as reported by some patients. Therefore, an embodiment of the invention may provide a planning mode. In this case, the surgeon interacting with an embodiment of the invention may iteratively alter the position of the bar underneath the sternum. Changes in geometry of the ribcage affect the external shape of the chest, which is one of the main goals of the Nuss procedure. In an embodiment of the invention, the predicted shape may be compared with an average shaped chest in order to objectively assess aesthetic outcome and overall improvement.

An average shape may be defined and used for evaluation of the plan developed by the surgeon during training according to an embodiment of the invention. This average may be developed, e.g., based on a sample of normal subjects surface scans. Development of one such average is described below.

An average shape may also be used in connection with a methodology to objectively assess aesthetic improvement of the PE chest and to determine if an objective assessment of physiological improvement is also possible using before and after chest surface comparison techniques.

It will be appreciated that a simulator according to an embodiment of the invention may be used, e.g., for training purposes. For example, a person being trained may carry out one or more simulated procedures using a model based on, e.g., an actual or hypothetical patient.

Validation of the system may also be performed by testing the planner with previously operated cases. A user would recreate a scenario, e.g., the ribcage geometry and location of the bar, and compare a simulated outcome with the actual result. In this way, different cases can be studied in order to prove that the solution accomplishes its intended results.

An embodiment of the invention may involve one or more of, e.g., acquisition of data analysis, modeling, and simulation, any or all of which may be accomplished by one or more programmable digital computers and/or using one or more computer-readable storage media. FIG. 6 is a block diagram of a representative computer system 140 such as may be used in connection with an embodiment of the invention.

The computer system 140 includes at least one processor 145, such as, e.g., an Intel Core™ 2 microprocessor or a Freescale™ PowerPC™ microprocessor, coupled to a communications channel 147. The computer system 140 further includes at least one input device 149 such as, e.g., a keyboard, mouse, touch pad or screen, or other selection, pointing, and/or input device, at least one output device 151 such as, e.g., a CRT or LCD display, a communications interface 153, a data storage device 155, which may comprise, e.g., a magnetic disk, an optical disk, and/or an other computer-readable storage medium, and memory 157 such as Random-Access Memory (RAM), each coupled to the communications channel or bus 147. The communications interface 153 may be coupled to a network 142 such as the Internet.

A computer system in connection with an embodiment of the invention may comprises input and/or output devices adapted for use with modeling and/or simulation. Such devices may include, for example, a 3D monitor, a 3D projector, and/or virtual reality glasses. Input and tactile feedback may be achieved through, e.g., commercially available devices such as Sensable Technologies' PHANTOM OMNI or PHANTOM DESKTOP device, among other possibilities.

A person skilled in the art will recognize that a computer system may have multiple channels 112, which may be interconnected. In a configuration comprising multiple interconnected channels, components may be considered to be coupled to one another, despite being directly connected to different communications channels. Additionally, any connection between or among any one or more components may include one or more interfaces.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store instructions executable by one or more processors 145 or kinds of processors, data, or both, which may represent, e.g., one or more operating systems, programs, and/or other data.

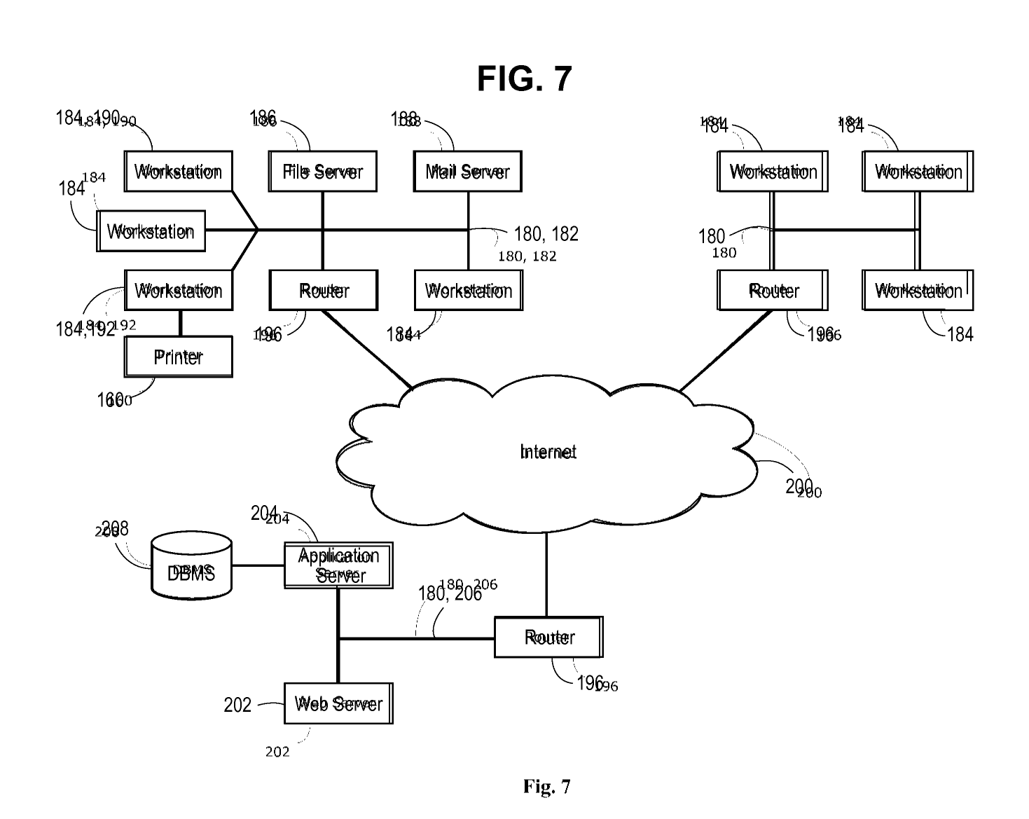

Two or more computer systems 140 may be connected, e.g., in one or more networks, via, e.g., their respective communications interfaces 155 and/or network interfaces (not depicted). FIG. 7 is a block diagram of representative interconnected networks 180, such as may be useful in connection with embodiments of the invention. A network 182 may, for example, connect one or more workstations 184 with each other and with other computer systems, such as file servers 186 or mail servers 188. The connection may be achieved tangibly, e.g., via optical cables, or wirelessly.

A network 180 may enable a computer system to provide services to other computer systems, consume services provided by other computer systems, or both. For example, a file server 186 may provide common storage of files for one or more of the workstations 184 on a network 182. A workstation 190 may send data including a request for a file to the file server 186 via the network 182 and the file server 186 may respond by sending the data from the file back to the requesting workstation 190.

The terms “workstation,” “client,” and “server” may be used herein to describe a computer's function in a particular context, but any particular workstation may be indistinguishable in its hardware, configuration, operating system, and/or other software from a client, server, or both. Further, a computer system may simultaneously act as a workstation, a server, and/or a client. For example, as depicted in FIG. 7, a workstation 192 is connected to a printer 194. That workstation 192 may allow users of other workstations on the network 182 to use the printer 194, thereby acting as a print server. At the same time, however, a user may be working at the workstation 192 on a document that is stored on the file server 186.

A network 182 may be connected to one or more other networks 180, e.g., via a router 196. A router 196 may also act as a firewall, monitoring and/or restricting the flow of data to and/or from a network 180 as configured to protect the network. A firewall may alternatively be a separate device (not pictured) from the router 196.

A network of networks 180 may be referred to as an internet. The term “the Internet” 200 refers to the worldwide network of interconnected, packet-switched data networks that uses the Internet Protocol (IP) to route and transfer data. A client and server on different networks may communicate via the Internet 200. For example, a workstation 190 may request a World Wide Web document from a Web Server 202. The Web Server 202 may process the request and pass it to, e.g., an Application Server 204. The Application Server 204 may then conduct further processing, which may include, for example, sending data to and/or receiving data from one or more other data sources. Such a data source may include, e.g., other servers on the same network 206 or a different one and/or a Database Management System (“DBMS”) 208.

The terms “client” and “server” may describe programs and running processes instead of or in addition to their application to computer systems described above. Generally, a (software) client may consume information and/or computational services provided by a (software) server.

1. A method of simulating, with a computer system that comprises at least one processor, a surgical procedure intended to modify the shape of an anatomic structure of a patient's body, the method comprising:
receiving through an interface operatively coupled to at least one of the processors data that comprises measurements of physical attributes of the anatomic structure;
executing instructions by at least one of the processors to map the measurements to a plurality of parameters of a computerized parametric model of the anatomic structure;
generating a first model of the anatomic structure based on a parametric model of the anatomic structure and the mapped measurements; and
using the first model directly or indirectly to simulate interactively the response of the anatomic structure to simulated actions of a surgeon performing the surgical procedure.

2. The method of claim 1, wherein simulating interactively the response of the anatomic structure to simulated actions of a surgeon performing the surgical procedure comprises repeatedly:
receiving from at least one input device operatively coupled to at least one of the processors input that represents application of one or more forces during surgery to one or more parts of the anatomic structure;
in response to the received input that represents application of one or more forces during surgery, executing instructions by at least one of the processors to calculate, using the first model directly or indirectly, one or more resulting forces and one or more displacements of the anatomic structure in response to the applied forces; and
transmitting to at least one output device operatively coupled to at least one of the processors output representing one or more of the resulting forces, one or more of the displacements, or both.

3. The method of claim 2, wherein:
the computer system comprises a positional input device that comprises an element that is capable of detecting movement in three dimensions; and
the input provided by the positional input device includes information representing all dimensions of movement of the element.

4. The method of claim 3, wherein the computer system comprises a haptic output device.

5. The method of claim 4, wherein:
the positional input device and the haptic output device are the same device;
the output provided to the haptic output device represents one or more resulting forces; and
the haptic output device exerts a force on a user that corresponds to the one or more resulting forces.

6. The method of claim 2, wherein the first model comprises a finite element model.

7. The method of claim 6, comprising generating a second model based on the first model, wherein:
the second model comprises an artificial neural network;
generating the second model comprises using the first model to simulate the response of the anatomic structure to application of one or more external forces;
the first model is used indirectly to simulate interactively the response of the anatomic structure to the simulated actions of the surgeon performing the surgical procedure; and
using the first model indirectly to simulate the response of the anatomic structure to the simulated actions of the surgeon comprises using the second model directly to simulate the response of the anatomic structure to the simulated actions of the surgeon.

8. The method of claim 2, wherein:
the surgical procedure comprises insertion of one or more curved metal bars into the chest of a patient to correct an abnormal depression of the patient's sternum; and
the anatomic structure comprises the patient's ribcage and associated tissues.

9. The method of claim 8, comprising receiving through an interface operatively coupled to at least one or the processors information representing the sizes and shapes of the metal bars, wherein simulating the response of the anatomic structure reflects the information representing the sizes and shapes of the metal bars.

10. A computer system for simulating a surgical procedure intended to modify the shape of an anatomic structure of a patient's body, the computer system comprising:
at least one processor;
at least one interface operatively coupled to at least one of the processors; and
a computer-readable storage medium operatively coupled to at least one of the processors and encoded with instructions that, when executed by a least one of the processors, cause the computer system at least to
receive through one of the interfaces data that comprises measurements of physical attributes of the anatomic structure;
map the measurements to a plurality of parameters of a computerized parametric model of the anatomic structure;
generate a first model of the anatomic structure based on a parametric model of the anatomic structure and the mapped measurements; and
use the first model directly or indirectly to simulate interactively the response of the anatomic structure to simulated actions of a surgeon performing the surgical procedure.

11. The computer system of claim 10, comprising:
at least one input device operatively coupled to at least one of the processors; and
at least one output device operatively coupled to at least one of the processors;
wherein simulating interactively the response of the anatomic structure to simulated actions of a surgeon performing the surgical procedure comprises repeatedly:
receiving from at least one of the input devices input that represents application of one or more forces during surgery to one or more parts of the anatomic structure;
in response to the received input that represents application of one or more forces during surgery, executing instructions by at least one of the processors to calculate, using the first model directly or indirectly, one or more resulting forces and one or more displacements of the anatomic structure in response to the applied forces; and
transmitting to at least one of the output devices output representing one or more of the resulting forces, one or more of the displacements, or both.

12. The computer system of claim 11, wherein:
at least one of the input devices is a positional input device that comprises an element that is capable of detecting movement in three dimensions; and
the input provided by the positional input device includes information representing all dimensions of movement of the element.

13. The computer system of claim 12, wherein at least one of the output devices is a haptic output device.

14. The computer system of claim 13, wherein:
the positional input device and the haptic output device are the same device;
the output provided to the haptic output device represents one or more resulting forces; and
the haptic output device exerts a force on a user that corresponds to the one or more resulting forces.

15. The computer system of claim 11, wherein the first model comprises a finite element model.

16. The computer system of claim 15, wherein:
the instructions comprise instructions that, when executed by at least one of the processors, cause the computer system at least to generate a second model based on the first model;
the second model comprises an artificial neural network;
generating the second model comprises using the first model to simulate the response of the anatomic structure to application of one or more external forces;
the first model is used indirectly to simulate interactively the response of the anatomic structure to the simulated actions of the surgeon performing the surgical procedure; and
using the first model indirectly to simulate the response of the anatomic structure to the simulated actions of the surgeon comprises using the second model directly to simulate the response of the anatomic structure to the simulated actions of the surgeon.

17. The computer system of claim 11, wherein:
the surgical procedure comprises insertion of one or more curved metal bars into the chest of a patient to correct an abnormal depression of the patient's sternum; and
the anatomic structure comprises the patient's ribcage and associated tissues.

18. The computer system of claim 17, wherein:
the instructions comprise instructions that, when executed by at least one of the processors, cause the computer system at least to receive through an interface operatively coupled to at least one or the processors information representing the sizes and shapes of the metal bars; and
simulating the response of the anatomic structure reflects the information representing the sizes and shapes of the metal bars.

19. A computer-readable storage medium encoded with instructions that, when executed by at least one processor within a computer system, cause the computer system to carry out a method of simulating a surgical procedure intended to modify the shape of an anatomic structure of a patient's body, the method comprising:
receiving through an interface operatively coupled to at least one of the processors data that comprises measurements of physical attributes of the anatomic structure;
executing instructions by at least one of the processors to map the measurements to a plurality of parameters of a computerized parametric model of the anatomic structure;
generating a first model of the anatomic structure based on a parametric model of the anatomic structure and the mapped measurements; and
using the first model directly or indirectly to simulate interactively the response of the anatomic structure to simulated actions of a surgeon performing the surgical procedure.

20. The computer-readable storage medium of claim 19, wherein simulating interactively the response of the anatomic structure to simulated actions of a surgeon performing the surgical procedure comprises repeatedly:
receiving from at least one input device operatively coupled to at least one of the processors input that represents application of one or more forces during surgery to one or more parts of the anatomic structure;
in response to the received input that represents application of one or more forces during surgery, executing instructions by at least one of the processors to calculate, using the first model directly or indirectly, one or more resulting forces and one or more displacements of the anatomic structure in response to the applied forces; and
transmitting to at least one output device operatively coupled to at least one of the processors output representing one or more of the resulting forces, one or more of the displacements, or both.

21. The computer-readable storage medium of claim 20, wherein, when the instructions are executed by a processor within a computer system that comprises a positional input device that comprises an element that is capable of detecting movement in three dimensions, they cause the computer system at least to receive input provided by the positional input device that includes information representing all dimensions of movement of the element.

22. The computer-readable storage medium of claim 21, wherein, when the instructions are executed by a processor within a computer system that comprises a positional input device that is also a haptic output device, they cause the computer system at least to provide output to the haptic output device that represents one or more resulting forces, such that the output is capable of causing the haptic output device to exert a force on a user that corresponds to the one or more resulting forces.

23. The computer-readable storage medium of claim 20, wherein the first model comprises a finite element model.

24. The computer-readable storage medium of claim 23, wherein:
when the instructions are executed by at least one processor within the computer system, they cause the computer system at least to generate a second model based on the first model;
the second model comprises an artificial neural network;
generating the second model comprises using the first model to simulate the response of the anatomic structure to application of one or more external forces;
the first model is used indirectly to simulate interactively the response of the anatomic structure to the simulated actions of the surgeon performing the surgical procedure; and
using the first model indirectly to simulate the response of the anatomic structure to the simulated actions of the surgeon comprises using the second model directly to simulate the response of the anatomic structure to the simulated actions of the surgeon.

25. The method of claim 20, wherein:
the surgical procedure comprises insertion of one or more curved metal bars into the chest of a patient to correct an abnormal depression of the patient's sternum; and
the anatomic structure comprises the patient's ribcage and associated tissues.

26. The method of claim 25, wherein:
when the instructions are executed by at least one processor within the computer system, they cause the computer system at least to receive through an interface operatively coupled to at least one or the processors information representing the sizes and shapes of the metal bars; and
simulating the response of the anatomic structure reflects the information representing the sizes and shapes of the metal bars.
